(19) United States
(12) Patent Application Publication
(10) Pub. No.: US 2014/0033216 A1
(43) Pub. Date: Jan. 30, 2014

(54) TASK PROCESSING METHOD AND DEVICE

(71) Applicant: Tencent Technology (Shenzhen) Company Limited, Shenzhen (CN)

(72) Inventors: Qing WANG, Shenzhen (CN); Haoran GUO, Shenzhen (CN); Yixia YUAN, Shenzhen (CN); Xunchang ZHAN, Shenzhen (CN); Chunyou LIN, Shenzhen (CN); Pengtao LI, Shenzhen (CN); Jiashun SONG, Shenzhen (CN)

(73) Assignee: Tencent Technology (Shenzhen) Company Limited, Shenzhen (CN)

(21) Appl. No.: 14/043,767

(22) Filed: Oct. 1, 2013

Related U.S. Application Data
(63) Continuation of application No. PCT/CN2013/080192, filed on Jul. 26, 2013.

(30) Foreign Application Priority Data
Jul. 30, 2012 (CN) 201210268333.3

(51) Int. Cl. G06F 9/48

(52) U.S. Cl. CPC G06F 9/48
USPC 718/102

(57) ABSTRACT

The present invention relates to the field of computer technologies, and disclosed are a task processing method and an associated mobile terminal for performing the method. The method includes: scanning an application program, so as to obtain a list of predefined tasks corresponding to the application program; comparing the list of predefined tasks with a preset white list of tasks; removing a matched task from the list of predefined tasks, so as to obtain a new task list, so that a user selects a task according to a need from the new task list for execution; detecting one or more user selections of members of the new task list; updating the new task list and the preset white list of tasks according to the user selections; and performing the updated new task list using the application program.

### RELATED APPLICATION

This application is a continuation application of PCT Patent Application No. PCT/CN2013/080192, entitled “TASK PROCESSING METHOD AND DEVICE,” filed on Jul. 26, 2013, which claims priority to Chinese Patent Application No. 201210268333.3, entitled “TASK PROCESSING METHOD AND DEVICE,” filed on Jul. 30, 2012, both of which are incorporated by reference in their entirety.

### TECHNICAL FIELD

The disclosed implementations relate generally to the field of computer technologies, and in particular, to a task processing method and device.

### BACKGROUND

With the development of computer technologies, the number of application programs on a terminal platform increases daily, and more and more users are keen to use powerful management software to perform a management service on the application program. The management software may provide a corresponding task for the application program, and the user performs corresponding processing on the task. For example, the management service provides an uninstall task for an application installed in a mobile phone by a user, and the uninstall task of each application is executed through checking of the user. The number of the application programs is large, and therefore, a manner of processing tasks in batches needs to be implemented, so as to accelerate the operation and improve management efficiency.

The existing manner of processing tasks in batches is: the management software first scans the application program, and then provides a list of predefined tasks relevant to the application program. The management software acquires some tasks from the provided list of predefined tasks according to a preset rule so as to recommend them to the user. For example, in the list of predefined tasks of the uninstall, the management service pre-stores all marks of the user to various applications according to a marking mechanism, and an uninstall task of an application whose mark is lower than a certain score is regarded as a recommended task, which is presented as a task list having a checkbox option checked by default to the user. Under the guide of this recommendation, the user performs manual selection for processing in combination of his/her own judgment.

During the implementation of the present invention, the inventors find that the prior art has at least the following problem:

In the prior art, the task may be recommended through a preset rule, but the preset rule cannot cover all the application programs and scenarios, and further cannot satisfy personalized selection of the user. For example, when the user does not completely or completely does not accept the recommended task, the user may need to perform a modification operation for multiple times, for example, clearing up a checked option, and checking an unchecked option again. In addition, if the user deletes an application program carelessly, while the user does not want to delete the program, it may also result in the reduced user experience and economic loss.

### SUMMARY

In order to solve problems in the prior art, embodiments of the present invention provide a task processing method. The technical solutions are as follows:

In one aspect, a task processing method is provided and performed at a mobile terminal having one or more processors and memory for storing programs to be executed by the one or more processors, where the method includes:

scanning an application program, so as to obtain a list of predefined tasks corresponding to the application program;

comparing the list of predefined tasks with a preset white list of tasks;

removing a matched task from the list of predefined tasks, so as to obtain a new task list, so that a user selects a task according to the need from the new task list for execution;

detecting one or more user selections of members of the new task list;

updating the new task list and the preset white list of tasks according to the user selections; and

performing the updated new task list using the application program.

Preferably, the comparing the list of predefined tasks with a preset white list of tasks further includes:

selecting a task from the list of predefined tasks;

querying the white list of tasks for the selected task; and

identifying the selected task as the matched task if it has a match in the preset white list of tasks.

Preferably, the method further includes:

after removing the matched task from the list of predefined tasks, so as to obtain a new task list, so that a user selects a task according to the need from the new task list for execution, concurrently displaying the new task list and the white list.

Preferably, the method further includes:

after removing the matched task from the list of predefined tasks, so as to obtain a new task list, so that a user selects a task according to the need from the new task list for execution, acquiring a to-be-recovered task, which is selected by the user from the white list; and adding the to-be-recovered task to the new task list.

Preferably, the method further includes:

after removing the matched task from the list of predefined tasks, so as to obtain a new task list, so that a user selects a task according to the need from the new task list for execution, transferring one or more user-unselected task from the new task list to the white list.

In another aspect, a task processing mobile terminal is provided, where the mobile terminal includes:

one or more processors;

memory; and

one or more program modules stored in the memory and to be executed by the one or more processors, the one or more program modules further including:

a scanning module, configured to scan an application program, so as to obtain a list of predefined tasks corresponding to the application program;

a matching module, configured to compare the list of predefined tasks with a preset white list of tasks; and

a processing module, configured to remove a matched task from the list of predefined tasks, so as to obtain a new task list, so that a user selects a task according to a need from the new task list for execution, detect one or more user selections of members of the new task list, update the new task list and the preset white list of tasks according to the user selections, and perform the updated new task list using the application program.

Preferably, the matching module further includes:

a selecting unit, configured to select a task from the list of predefined tasks;

a query unit, configured to query the white list of tasks for the selected task; and

a matching unit, configured to identify the selected task as the matched task if it has a match in the preset white list of tasks.

Preferably, the one or more program modules further include:

a displaying module, configured to concurrently display the new task list and the white list.

Preferably, the one or more program modules further include:

a recovering module, configured to acquire a to-be-recovered task, which is selected by the user from the white list, and add the to-be-recovered task to the new task list.

Preferably, the one or more program modules further include:

a recording module, configured to transfer one or more user-unselected task from the new task list to the white list.

In yet another aspect, a non-transitory computer readable storage medium storing one or more programs configured for execution by a mobile terminal having one or more processors and memory storing one or more programs for execution by the one or more processors, the one or more programs comprising executable instructions for: scanning an application program, so as to obtain a list of predefined tasks corresponding to the application program; comparing the list of predefined tasks with a preset white list of tasks; removing a matched task from the list of predefined tasks, so as to obtain a new task list, so that a user selects a task according to a need from the new task list for execution; detecting one or more user selections of members of the new task list; updating the new task list and the preset white list of tasks according to the user selections; and performing the updated new task list using the application program.

The technical solutions provided by the embodiments of the present invention bring the following beneficial effects:

In the embodiments, the white list is preset, the application program is scanned, and all the tasks relevant to the application program are obtained. Afterwards, the tasks are matched with the task that is recorded in the white list but not executed by the user, and the matched task is removed from the tasks, so as to obtain a remaining task for the user. The white list provides personalized selection and customization for the user to manage tasks in batches, thereby saving the operation time of the user, reducing a misoperation rate of the user, and improving the user experience.

### BRIEF DESCRIPTION OF DRAWINGS

The aforementioned implementation of the invention as well as additional implementations will be more clearly understood as a result of the following detailed description of the various aspects of the invention when taken in conjunction with the drawings. Like reference numerals refer to corresponding parts throughout the several views of the drawings.

To illustrate the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and persons of ordinary skill in the art can derive other drawings from these accompanying drawings without creative efforts.

FIG. 1 is a flow chart of a task processing method provided in Embodiment 1 of the present invention;

FIG. 2 is a flow chart of a task processing method provided in Embodiment 2 of the present invention;

FIG. 3 is a diagram illustrating the principle of the task processing method provided in Embodiment 2 of the present invention;

FIG. 4 is a diagram illustrating an interface of the task processing method provided in Embodiment 2 of the present invention;

FIG. 5 is a diagram illustrating an interface of the task processing method provided in Embodiment 2 of the present invention;

FIG. 6 is a schematic structural diagram of a task processing mobile terminal provided in Embodiment 3 of the present invention;

FIG. 7 is a schematic structural diagram of a matching module provided in Embodiment 3 of the present invention;

FIG. 8 is a schematic structural diagram of a task processing mobile terminal provided in Embodiment 3 of the present invention;

FIG. 8 is a schematic structural diagram of a task processing mobile terminal provided in Embodiment 3 of the present invention;

FIG. 10 is a schematic structural diagram of a task processing mobile terminal provided in Embodiment 3 of the present invention; and

FIG. 11 is a block diagram of a mobile terminal for task processing according to some implementations.

### DETAILED DESCRIPTION

To make the objectives, technical solutions, and advantages of the present invention clearer, the embodiments of the present invention are described in further detail below with reference to the accompanying drawings.

### Embodiment 1

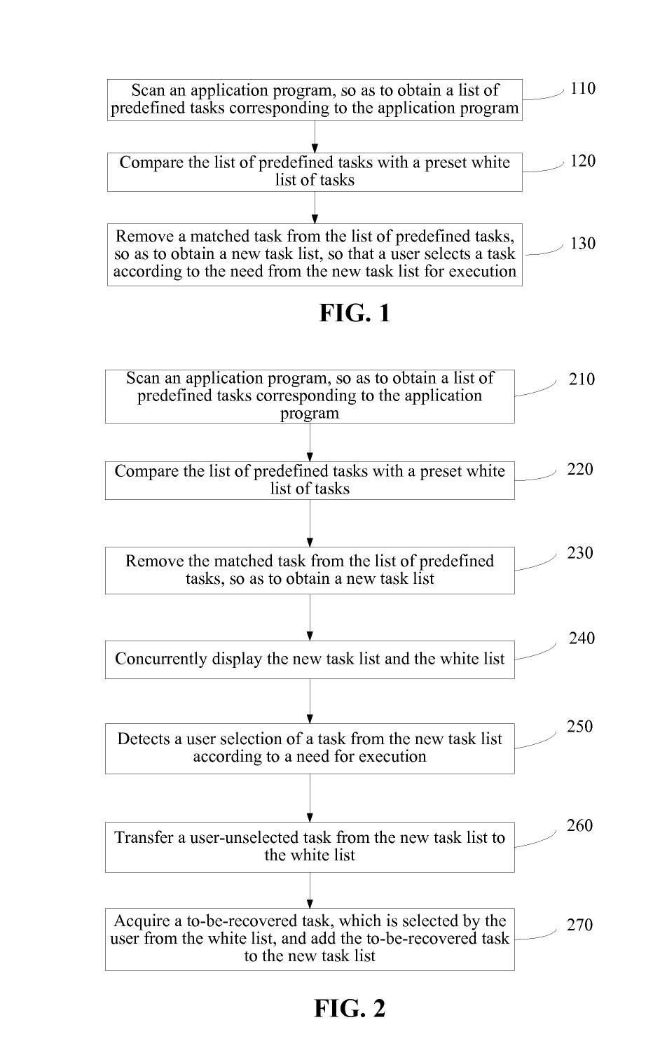

Referring to FIG. 1, this embodiment provides a method relevant to task processing. The method includes the following steps:

Step 110: Scan an application program, so as to obtain a list of predefined tasks corresponding to the application program.

Step 120: Compare the list of predefined tasks with a preset white list of tasks.

Step 130: Remove a matched task from the list of predefined tasks, so as to obtain a new task list, so that a user selects a task according to the need from the new task list for execution.

In some embodiments, step 130 further includes: detecting one or more user selections of members of the new task list; updating the new task list and the preset white list of tasks according to the user selections; and performing the updated new task list using the application program.

Specifically, the comparing the list of predefined tasks with a preset white list of tasks further includes:

selecting a task from the list of predefined tasks;

querying the white list of tasks for the selected task; and

identifying the selected task as the matched task if it has a match in the preset white list of tasks.

Further, the method further includes:

after removing the matched task from the list of predefined tasks, so as to obtain a new task list, so that a user selects a task according to the need from the new task list for execution, concurrently displaying the new task list and the white list.

Further, the method further includes:

after removing the matched task from the list of predefined tasks, so as to obtain a new task list, so that a user selects a task according to the need from the new task list for execution, acquiring a to-be-recovered task, which is selected by the user from the white list; and adding the to-be-recovered task to the new task list.

Further, the method further includes:

after removing the matched task from the list of predefined tasks, so as to obtain a new task list, so that a user selects a task according to the need from the new task list for execution, transferring one or more user-unselected task from the new task list to the white list.

In this embodiment, the white list is preset, the application program is scanned, and all the tasks relevant to the application program are obtained. Afterwards, the tasks are matched with the task that is recorded in the white list but not executed by the user, and the matched task is removed from the tasks, so as to obtain a remaining task for the user. The white list provides personalized selection and customization for the user to manage tasks in batches, thereby saving the operation time of the user, reducing a misoperation rate of the user, and improving the user experience.

### Embodiment 2

Referring to FIG. 2, this embodiment provides a task processing method, and specific steps are as follows:

Step 210: Scan an application program, so as to obtain a list of predefined tasks corresponding to the application program.

Specifically, a mobile phone is taken as an example in this embodiment, but the content described in the embodiment of the present invention is also applicable to another terminal with a function of processing tasks in batches.

In order to manage the operation of a mobile phone, the mobile phone starts management software, and the management software scans, according to service content, all application programs corresponding to the service content, so as to further obtain tasks relevant to the application programs, and the relevant tasks form a list of predefined tasks corresponding to the service content. For example, an application program running on the mobile phone usually has one or more processes associated with the application program. The management software may be used for managing the processes associated with multiple application programs running on the mobile phone so that a user can instruct the management software to perform certain types of default batch operations against the processes (e.g., starting or stopping the processes). On the other hand, the user of the mobile phone often find that it is more convenient from the user's perspective that some of the application programs should be exempted from such default batch operations. One aspect of the present invention is to provide a mechanism so that the user can easily free some of the application programs (or in some cases, their corresponding processes) from the default batch operations.

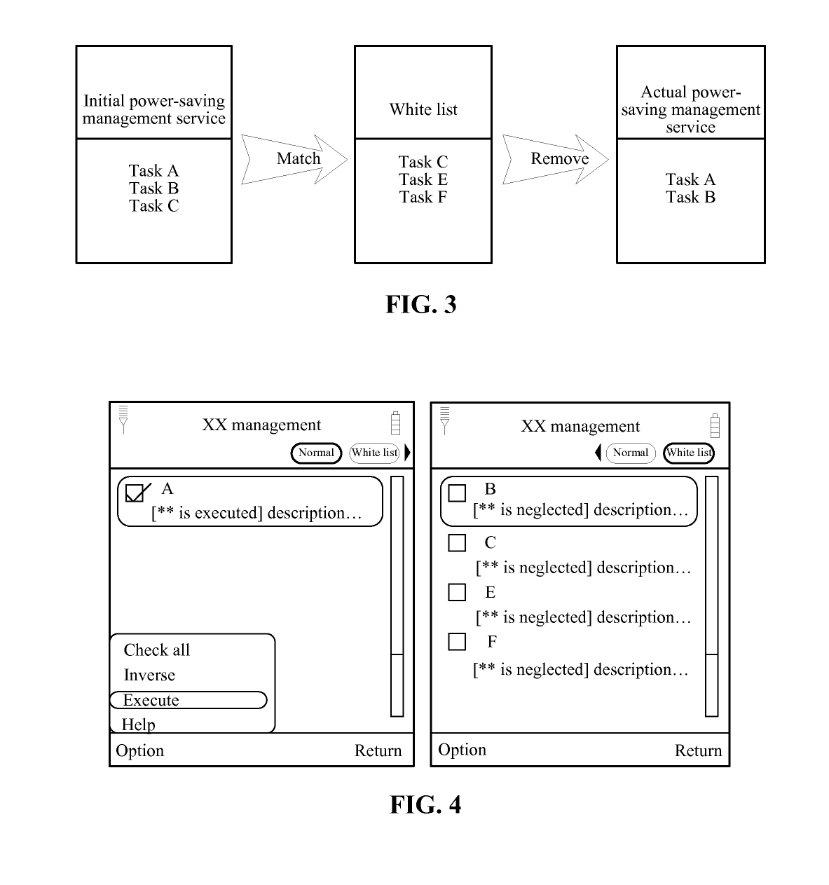

For example, referring to FIG. 3, when a user wants to manage the operation of a mobile phone, the mobile phone starts management software. If the service content associated with the software is a power-saving service, application programs corresponding to the service content are application programs running in the background. At this time, the management software scans the application programs running in the background, so as to obtain relevant tasks, which are operations for closing the application programs running in the background of the mobile phone, and the relevant tasks form a list of predefined tasks of the current power-saving service.

In another example, when the user manages the operation of the mobile phone, the service content may also be an upgrade service or an uninstall service. When the service content is the upgrade service, application programs corresponding to the service content are all application programs installed in the mobile phone. At this time, the management software scans all the application programs installed in the mobile phone, so as to obtain relevant tasks, which are operations for upgrading the application programs to their respective new versions among all the application programs, and the relevant tasks form a list of predefined tasks of the upgrade service. Similarly, when the service content is the uninstall service, application programs corresponding to the service content are all the application programs installed in the mobile phone. At this time, the management software scans all the application programs installed in the mobile phone, so as to obtain relevant tasks, which are operations for uninstalling the application programs. The relevant tasks form a list of predefined tasks of the uninstall service.

Step 220: Compare the list of predefined tasks with a preset white list of tasks.

In this embodiment, the preset white list of tasks include multiple tasks associated with for the management software, each of which relates to an operation to be applied to an application program that has not been selected by the user in a previous operation of processing tasks in batches corresponding to the service content. For the same task that has been selected and unselected by the user previously, the population of the white list is subject to the latest user operation. For details, reference may be made to the update part about the white list of step 260.

The white list is preset to record a personal usage habit of the user through recording each time the task that is not selected by the user but relevant to the application program. In this embodiment, different service contents may correspond to different white lists, or all tasks relevant to the application program in the management service may be recorded by using one white list, which is not specifically limited herein. Meanwhile, the white list may be stored in the mobile phone locally, or a portable storage device such as a flash memory card, or a server, which is flexible, so as to adapt to different needs. The white list may be downloaded according to the need when it is stored in the server.

The comparing the list of predefined tasks with a preset white list of tasks specifically is, selecting a task from the list of predefined tasks, querying the white list of tasks for the selected task, comparing the selected task with the relevant tasks in the white list, and identifying the selected task as the matched task if it has a match in the preset white list of tasks.

As a continuation of what is shown in FIG. 3, the service content of the management software is the power-saving service in step 210, three application programs running in the background, namely, a weather broadcast program, a browser program, and a music program, are scanned so as to obtain a list of predefined tasks, and the list of predefined tasks includes a task A for closing the weather broadcast program, a task B for closing the browser program, and a task C for closing the music program. In this step, a task corresponding to the power-saving service in the preset white list is queried, and the task in the list of predefined tasks is compared with the task corresponding to the power-saving management in the white list. If a task identical to the task C for closing the music program in the white list exists in the task list, the task C for closing the music program is regarded as the matched task.

In addition, if service content is started for the first time, the white list may be null by default, or several tasks of commonly-used application programs corresponding to the service content may be pre-stored according to a preset rule before the white list records the usage habit of the user.

Step 230: Remove the matched task from the list of predefined tasks, so as to obtain a new task list.

After the foregoing steps are performed and the matched task is obtained according to the white list, the new task list may be presented in two different ways. One is that the new task list includes a list of predefined tasks having checkbox options, and after matching, a checkbox option of a task matched in the white list is null, and a checkbox option of another task not matched in the white list is checked. Preferable method 2 in this embodiment specifically is that: after matching with the white list, the matched tasks in the list of predefined tasks are removed, and the new task list contains tasks not matched in the white list and a corresponding checkbox option. An example of the method 2 is taken for illustration of subsequent steps.

As a continuation of the process of step 220 in FIG. 3, in the method 2 of this step, the matched task C for closing the music program is removed from the list of predefined tasks of the power-saving service, so as to obtain the remaining task A for closing the weather broadcast, and task B for closing the browser program, which serve as the new task list of the power-saving service.

Step 240: Concurrently display the new task list and the white list.

In the specific implementation manner for displaying the new task list and the white list, a display interface of the new task list and a display interface of the white list may be displayed together in an “and” manner through techniques such as split-screen, or displayed in an “or” manner by using two different display interfaces through techniques such as establishing a switching setting. As shown in FIG. 4, based on the “or” manner, two different switchable and interactive display interfaces are provided in this embodiment for the new task list and the white list, and the two display interfaces are only made for examples.

Step 250: Detect a user selection of a task from the new task list according to a need for execution.

After the matched tasks are removed from the list of predefined tasks, so as to obtain a new task list, the user performs a selection or cancellation operation on a task option provided in the new task list according to the need, and may execute the selected task after verifying.

As a continuation of the process of step 250 in the example of the management service, in this step, after checking the task A of three existing tasks A, B, and C, according to the need, the user clicks an execute button in an option menu, and an execution result is shown in FIG. 4. The left part of FIG. 4 shows that the task A in the new task list is executed, and the task B in an original new task list is removed.

Step 260: Transfer a user-unselected task from the new task list to the white list.

The white list is updated with the user-unselected tasks being moved to the white list after being executed each time, and the updated white list serves as a querying basis for next processing tasks in batches of the management software. The update means that if a task in the initial new task list after the white list is queried is not executed by the user, the task is added to the white list. The user may also access the white list, perform another update operation such as adding or deleting a task therein, and the edition manner and interface are not specifically limited herein. In other words, through user selection, a user of the mobile phone can specify certain tasks to be moved from the original list of predefined tasks to the white list by unchecking the checkbox associated with the tasks.

As a continuation of the process of step 250 in the example of the management service, in this step, referring to the right part of FIG. 4, after the task A is executed, tasks B, C, E, and F serve as the tasks not executed by the user in the white list, where the tasks C, E, and F already exist in the white list, and the updated task B is added to the white list. The updated white list added with the task B serves as a basis for querying the white list in the next execution of the management service after the application programs are scanned, so as to obtain a list of predefined tasks corresponding to the application program.

Further, if a next management service where the service content is applied obtains a list of predefined tasks including tasks of A, B, C, D (not shown before), E, and F after this step, after the step is performed again, the tasks displayed in the new task list should be tasks A and D (not shown before). The tasks displayed in the white list should be tasks B, C, E, and F.

Step 270: Acquire a to-be-recovered task, which is selected by the user from the white list, and add the to-be-recovered task to the new task list.

This step is an optional step, and specifically, due to different usage scenarios or current conditions, the user may expect that a task that is relevant to the application program but not selected during the previous management software execution is performed in the future usage. For example, for the task C for closing the music program of the power-saving service, the user selects not to close the music program only in a condition of listening to a specific piece of music. Therefore, in this step, the task recorded in the white list may be recovered, and the recovered task is added to the new task list again.

Specifically, after the application program is scanned, and the matched task relevant to the program is removed, the new task list and the white list are displayed in two independent pages, and the user may perform free switching and corresponding viewing and operations for an unlimited number of times through menu switching or left-right navigation. The new task list is displayed first by default, so that users who pursue convenience are capable of processing directly by skipping verifying the white list, or the white list may be displayed first.

Based on that the task list of a service is displayed first by default, the shortest operation path is implemented in this step, that is, the new task list—the update of the white list—the update of the new task list. The user first directly switches the new task list to the white list, verifies a task removed this time according to the actual need, and selects a to-be-recovered task. After the user confirms the selection, the management software deletes the to-be-recovered task from the deleted task of the white list, and recovers the task in the new task list. The foregoing operations may be omitted if there is no task expected to be recovered.

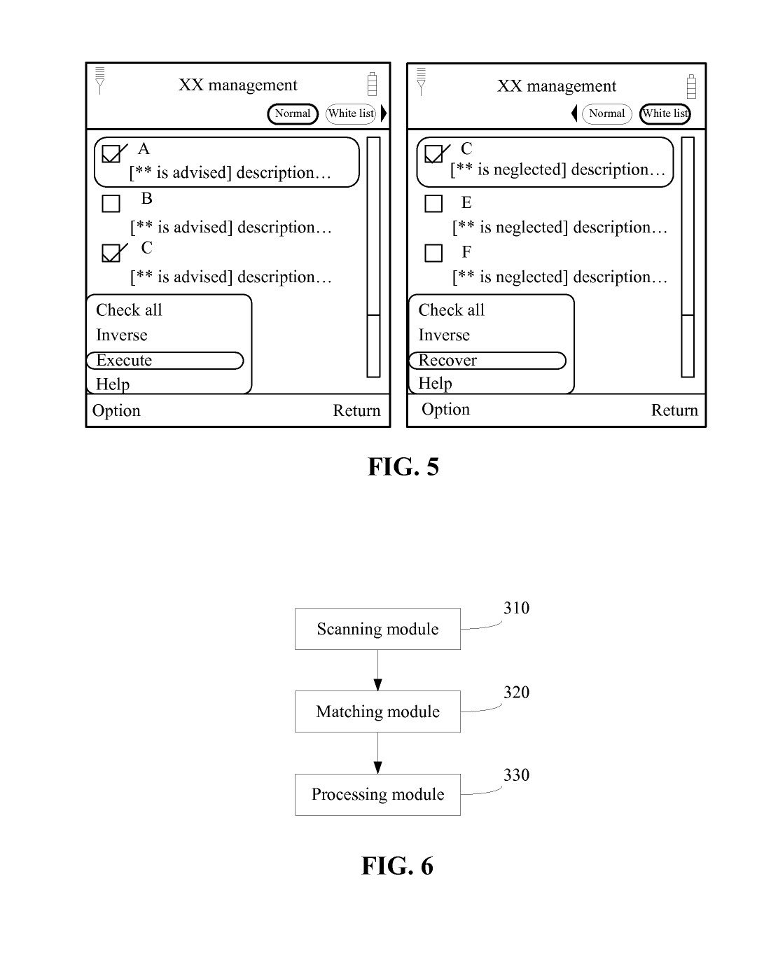

This step is a continuation of the process of step 230 and the displaying in step 240 in the example of the power-saving service, referring to a dynamic process from the right part to the left part in FIG. 5. In the right part, the user checks, in the white list, the deleted task C in step 230 which is expected to be executed, and clicks a recover button in the option. The management software recovers the task C from the white list to the new task list in the left part, and at this time, the task C is displayed in the list, and may be checked by default, the task C is not shown in the white list in the right part at this time, and the recovered task C may continue to execute a subsequent step.

The beneficial effects of this embodiment are as follows: The management service is run, so as to obtain the list of predefined tasks, the corresponding task is removed according to the white list, and the user selects the needed task for execution, thereby providing personalized selection and customization for selection and execution of the batch task management service of the user, saving the operation time of the user, and improving the user experience. Through an interaction page, the new task list and the white list are separated, and therefore, an independent operation can be performed through split-screen or free switching between the new task list and the white list can be performed through the switching setting. In the case where the to-be-recovered task selected by the user from the white list is acquired and the to-be-recovered task is added to the new task list so as to further ensure the personality, the independent selection of the user can be combined with the auto-selection function of the white list, so that the convenience and accuracy of processing tasks in batches in the management service are both considered. The task that is not selected for execution in the new task list is recorded in the white list, so that the white list has a self-learning function, and each time after the management service is done, the updated white list serves as the basis for next white list querying, so that the white list keeps tracking and updating a user habit on processing the task corresponding to the application program in the current batch management service, instead of irregularly updating a preset rule of a batch service only corresponding to the common user habit as conventional management software.

Note that the aforementioned user selection of tasks to be moved between the list of the predefined tasks, the white list, and the new task list is merely one way of customizing the operation of management software based on the user's need or personal choice. In some embodiments, the management software determines how to move a task from one list to another list based on monitoring the user activities on the task (or an application program associated with the task). In this case, there is no need for express user instruction for moving a task from, e.g., the list of predefined tasks to the white list or vice versa.

For example, the user may manually specify a predefined time period (e.g., a week) after the initial installation of the application program on the mobile phone for collecting the user activities on the task. In some embodiments, the collected user activities include one or more of: a period of time the user using a second application associated with the task, a number of times the user starting the second application, a number of times the user terminating the second application, and a number of times the user updating the second application. From these user activities, the management software can tell how frequently the user uses the application program. Generally speaking, the more often the user uses the application program, the more likely that the user may personalize the application program based on his or her own preference and the more appropriate that the task associated with the application program should be moved to the white list.

After a while, the user may change his or her habit of using the application program. For example, the user may significantly reduce the amount of time spent on the application program. In other words, the white list should be a dynamic one that varies over time. Instead of counting on the user to provide express instructions as to which task should be removed from the white list as described above in step 270, the management software may be invoked automatically to perform another round of monitoring the user activities on the task in the white list for a predefined time period. The management software then compares the monitored user activities with a set of predefined criteria to determine whether or not to remove the task from the white list. For example, the management software may decide to bring the task back to the new task list if the user activities have dropped by 50% during the time period. In some other embodiments, the set of predefined criteria is defined based on multiple users' usage pattern of a second application associated with the task. For example, the management software may decide to bring the task back to the new task list if the current user activities during the time period are less than 60% of the average user activities measured among a group of users having the same application program installed on their mobile phones. In yet some other embodiments, the management software may further divide the scenario in which the task is removed to the new task list into two sub-scenarios. For example, the task may be marked as a user-unselected task in the new task list if the monitored user activities satisfy a first set of predefined thresholds (e.g., 60% of the average user activities by a group of users or the same user). As noted above, the user-unselected task, if not expressly selected by the user, will return to the white list. In other words, the management software in this case is not certain whether the task should be in the new task list or the white list. It leaves the final decision to the user based on whether the user selects the task or not. Alternatively, the task may be marked as a user-selected task in the new task list if the monitored user activities satisfy a second set of predefined thresholds (e.g., 40% of the average user activities by a group of users or the same user). In this case, the second set of predefined thresholds is a subset of the first set of predefined thresholds. In other words, the management software determines that such a significant drop of user activities warrants that the task should be put back into the new task list for batch processing or operations because the user may no longer be interested in using the application program and having the task associated with the application program processed in a batch mode is more efficient.

Note that the user express selection of tasks and the implicit indication based on the variation of user activities can be used together for customizing the white list such that the user express selection (or unselection) constitutes major changes based on the user's preferences whereas the modification based on the variation of user activities plays the role of minor tuning of the white list to have it better in synch with the user's current personal preference.

### Embodiment 3

As shown in FIG. 6, this embodiment provides a task processing mobile terminal, where the device is configured to execute the task processing method provided in Embodiment 1 and Embodiment 2. The task processing mobile terminal further includes:

a scanning module 310, configured to scan an application program, so as to obtain a list of predefined tasks corresponding to the application program;

a matching module 320, configured to compare the list of predefined tasks with a preset white list of tasks; and

a processing module 330, configured to remove a matched task from the list of predefined tasks, so as to obtain a new task list, so that a user selects a task according to a need from the new task list for execution, detect one or more user selections of members of the new task list, update the new task list and the preset white list of tasks according to the user selections, and perform the updated new task list using the application program.

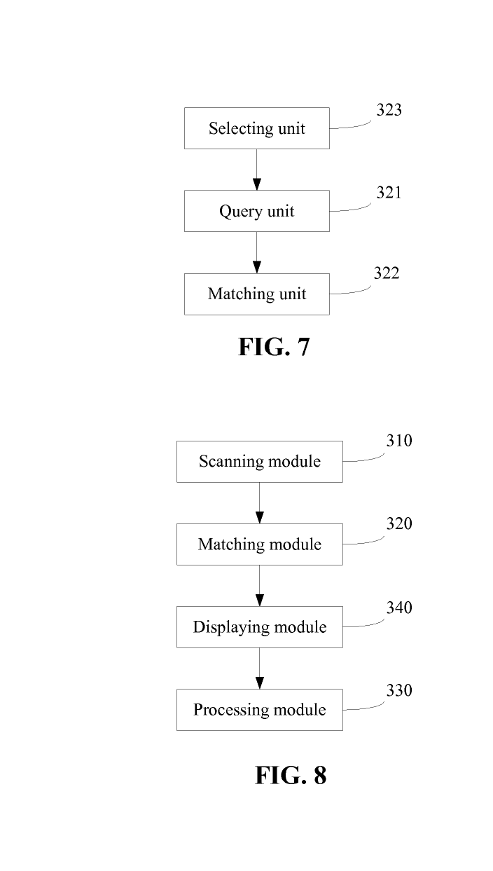

As shown in FIG. 7, the matching module 320 further includes:

a selecting unit 323, configured to select a task from the list of predefined tasks;

a query unit 321, configured to query the white list of tasks for the selected task; and

a matching unit 322, configured to identify the selected task as the matched task if it has a match in the preset white list of tasks.

The device shown in FIG. 8 further includes:

a displaying module 340, configured to concurrently display the new task list and the white list.

The device shown in FIG. 9 further includes:

a recovering module 350, configured to acquire a to-be-recovered task, which is selected by the user from the white list, and add the to-be-recovered task to the new task list.

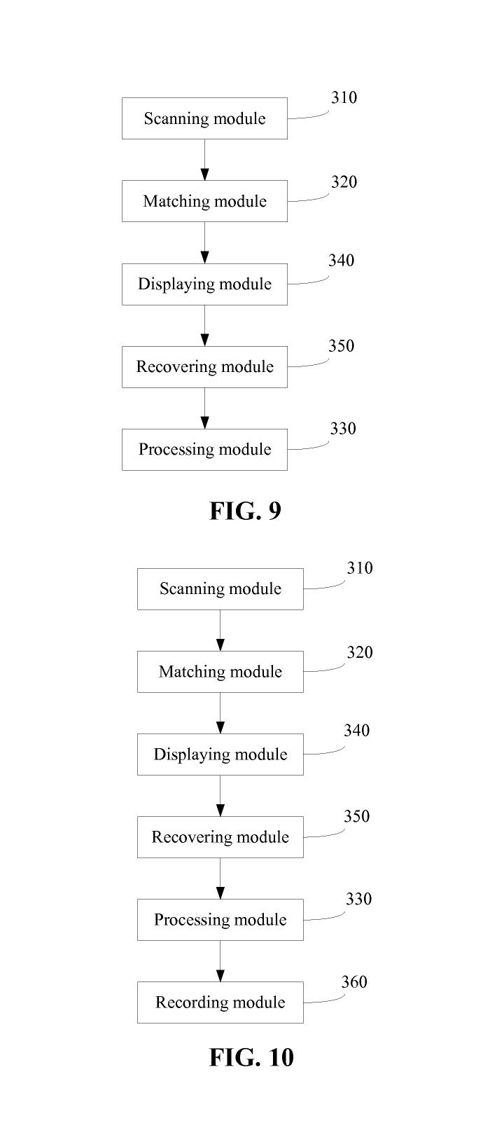

The device shown in FIG. 10 further includes:

a recording module 360, configured to transfer one or more user-unselected task from the new task list to the white list.

The device may specifically be implemented through mobile terminals such as a mobile phone, a tablet, or a personal digital assistant.

The beneficial effects of this embodiment are as follows: The scanning module runs the management service, so as to obtain the list of predefined tasks, the matching module removes the corresponding task according to the white list, and the user selects the needed task through the processing module for execution, thereby providing personalized selection and customization for selection and execution of the batch task management service of the user, saving the operation time of the user, and improving the user experience. Through an interaction page of the displaying module, the new task list and the white list are separated, and therefore, an independent operation can be performed through split-screen or free switching between the new task list and the white list can be performed through the switching setting. In the case where the recovering module acquires the to-be-recovered task selected by the user from the white list and adds the to-be-recovered task to the new task list so as to further ensure the personality, the independent selection of the user can be combined with the auto-selection function of the white list, so that the convenience and accuracy of processing tasks in batches in the management service are both considered. The recording module records the task that is not selected for execution in the new task list in the white list, so that the white list has a self-learning function, and each time after the management service is done, the updated white list serves as the basis for next white list querying, so that the white list keeps tracking and updating a user habit on processing the task corresponding to the application program in the current batch management service, instead of irregularly updating a preset rule of a batch service only corresponding to the common user habit as a conventional management software.

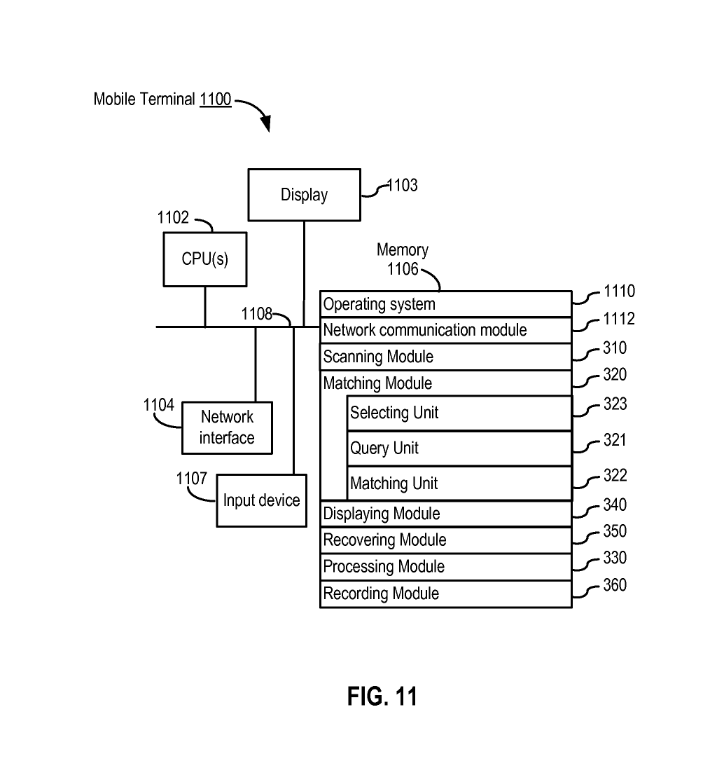

FIG. 11 is a block diagram of a mobile terminal 1100 for adaptively updating its software application's user interface based, at least in part, on the surrounding environment according to some implementations. The mobile terminal 1100 includes one or more processing units processors 1102, one or more network interfaces 1104, one or more input devices 1107, memory 1106, a display 1103, and one or more communication buses 1108 for interconnecting these components. The memory 1106 typically includes high-speed random access memory, such as DRAM, SRAM, or other random access solid state memory devices; and optionally includes non-volatile memory, such as one or more magnetic disk storage devices, optical disk storage devices, flash memory devices, or other non-volatile solid state storage devices. The memory 1106 optionally includes one or more storage devices remotely located from the processors 1102. The memory 1106 or alternatively the non-volatile memory device(s) within the memory 1106, comprises a non-transitory computer readable storage medium. In some implementations, the memory 1006 or alternatively the non-transitory computer readable storage medium stores the following programs, modules and data structures, or a subset thereof:
an operating system 1110 that includes procedures for handling various basic system services and for performing hardware dependent tasks;
a network communication module 1112 for connecting the mobile terminal 1100 with other devices (e.g., a remote server or other mobile terminals) via the network interface 1104 (wired or wireless);
a scanning module 310 as described herein;
a matching module 320 as described herein, the matching module 320 further including a selecting unit 323, a query unit 321, and a matching unit 322 as described herein;
a displaying module 340 as described herein;
a recovering module 350 as described herein;
a processing module 330 as described herein; and
a recording module 360 as described herein.

It should be noted that: when the task processing mobile terminal provided in the foregoing embodiments processes a task, only division of each function module is taken as an example for illustration. In actual application, the foregoing functions may be allocated to various function modules according to the need for execution. That is, the internal structure of the device is divided into various function modules, so as to implement all or a part of the functions described above. In addition, the task processing mobile terminal and the task processing method provided in the foregoing embodiments belong to a same idea, and for a specific implementation process, refer to the method embodiment, which is not described further herein.

Persons of ordinary skill in the art may understand that all or part of the steps of the method according to the embodiments may be implemented by a program instructing relevant hardware. The program may be stored in a computer readable storage medium, and the storage medium may be a read-only memory, a magnetic disk, or an optical disk, or the like.

The above descriptions are merely exemplary embodiments of the present invention, but are not intended to limit the present invention. Any modification, equivalent replacement, or improvement made without departing from the spirit and principle of the present invention should fall within the scope of the present invention.

While particular embodiments are described above, it will be understood it is not intended to limit the invention to these particular embodiments. On the contrary, the invention includes alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the embodiments.

Although the terms first, second, etc. may be used herein to describe various elements, these elements should not be limited by these terms. These terms are only used to distinguish one element from another. For example, first ranking criteria could be termed second ranking criteria, and, similarly, second ranking criteria could be termed first ranking criteria, without departing from the scope of the present invention. First ranking criteria and second ranking criteria are both ranking criteria, but they are not the same ranking criteria.

The terminology used in the description of the invention herein is for the purpose of describing particular embodiments only and is not intended to be limiting of the invention. As used in the description of the invention and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes”, “including”, “comprises”, and/or “comprising”, when used in this specification, specify the presence of stated features, operations, elements, and/or components, but do not preclude the presence or addition of one or more other features, operations, elements, components, and/or groups thereof.

As used herein, the term “if” may be construed to mean “when” or “upon” or “in response to determining” or “in accordance with a determination” or “in response to detecting”, that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

Although some of the various drawings illustrate a number of logical stages in a particular order, stages that are not order dependent may be reordered and other stages may be combined or broken out. While some reordering or other groupings are specifically mentioned, others will be obvious to those of ordinary skill in the art and so do not present an exhaustive list of alternatives. Moreover, it should be recognized that the stages could be implemented in hardware, firmware, software or any combination thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain principles of the invention and its practical applications, to thereby enable others skilled in the art to best utilize the invention and various implementations with various modifications as are suited to the particular use contemplated. Implementations include alternatives, modifications and equivalents that are within the spirit and scope of the appended claims. Numerous specific details are set forth in order to provide a thorough understanding of the subject matter presented herein. But it will be apparent to one of ordinary skill in the art that the subject matter may be practiced without these specific details. In other instances, well-known methods, procedures, components, and circuits have not been described in detail so as not to unnecessarily obscure aspects of the implementations.

What is claimed is:

1. A task processing method, comprising:
at a mobile terminal having one or more processors and memory for storing programs to be executed by the one or more processors:
scanning an application program, so as to obtain a list of predefined tasks corresponding to the application program;
comparing the list of predefined tasks with a preset white list of tasks;
removing a matched task from the list of predefined tasks, so as to obtain a new task list, so that a user selects a task according to a need from the new task list for execution;
detecting one or more user selections of members of the new task list;
updating the new task list and the preset white list of tasks according to the user selections; and
performing the updated new task list using the application program.

2. The method according to claim 1, wherein the comparing the list of predefined tasks with a preset white list of tasks further comprises:
selecting a task from the list of predefined tasks;
querying the white list of tasks for the selected task; and
identifying the selected task as the matched task if it has a match in the preset white list of tasks.

3. The method according to claim 1, further comprising:
after removing the matched task from the list of predefined tasks, so as to obtain a new task list, so that a user selects a task according to the need from the new task list for execution, concurrently displaying the new task list and the white list.

4. The method according to claim 1, further comprising:
after removing the matched task from the list of predefined tasks, so as to obtain a new task list, so that a user selects a task according to the need from the new task list for execution, acquiring a to-be-recovered task, which is selected by the user from the white list; and
adding the to-be-recovered task to the new task list.

5. The method according to claim 1, further comprising:
after removing the matched task from the list of predefined tasks, so as to obtain a new task list, so that a user selects a task according to the need from the new task list for execution, transferring one or more user-unselected task from the new task list to the white list.

6. The method according to claim 1, wherein the white list of tasks is updated by:
during a predefined time period:
monitoring user activities on a task in the white list of tasks; and
removing the task from the white list of tasks based on a comparison of the monitored user activities with a set of predefined criteria.

7. The method according to claim 6, wherein the monitored user activities include one or more of: a period of time the user using a second application associated with the task, a number of times the user starting the second application, a number of times the user terminating the second application, and a number of times the user updating the second application.

8. The method according to claim 6, wherein the set of predefined criteria is defined based on multiple users' usage pattern of a second application associated with the task.

9. The method according to claim 6, further comprising:
marking the task as a user-unselected task in the new task list if the monitored user activities satisfy a first set of predefined thresholds; and
marking the task as a user-selected task in the new task list if the monitored user activities satisfy a second set of predefined thresholds, wherein the second set of predefined thresholds is a subset of the first set of predefined thresholds.

10. A task processing mobile terminal, comprising:
one or more processors;
memory; and
one or more program modules stored in the memory and to be executed by the one or more processors, the one or more program modules further including:
a scanning module, configured to scan an application program, so as to obtain a list of predefined tasks corresponding to the application program;
a matching module, configured to compare the list of predefined tasks with a preset white list of tasks; and
a processing module, configured to remove a matched task from the list of predefined tasks, so as to obtain a new task list, so that a user selects a task according to a need from the new task list for execution, detect one or more user selections of members of the new task list, update the new task list and the preset white list of tasks according to the user selections, and perform the updated new task list using the application program.

11. The mobile terminal according to claim 10, wherein the matching module further comprises:
a selecting unit, configured to select a task from the list of predefined tasks;
a query unit, configured to query the white list of tasks for the selected task; and
a matching unit, configured to identify the selected task as the matched task if it has a match in the preset white list of tasks.

12. The mobile terminal according to claim 10, wherein the one or more program modules further include:
a displaying module, configured to concurrently display the new task list and the white list.

13. The mobile terminal according to claim 10, wherein the one or more program modules further include:
a recovering module, configured to acquire a to-be-recovered task, which is selected by the user from the white list, and add the to-be-recovered task to the new task list.

14. The mobile terminal according to claim 13, wherein the one or more program modules further include:
a recording module, configured to transfer one or more user-unselected task from the new task list to the white list.

15. The mobile terminal according to claim 10, wherein the white list of tasks is updated by:
during a predefined time period:
monitoring user activities on a task in the white list of tasks; and
removing the task from the white list of tasks based on a comparison of the monitored user activities with a set of predefined criteria.

16. The mobile terminal according to claim 15, wherein the monitored user activities include one or more of: a period of time the user using a second application associated with the task, a number of times the user starting the second application, a number of times the user terminating the second application, and a number of times the user updating the second application.

17. A non-transitory computer readable storage medium storing one or more programs configured for execution by a mobile terminal having one or more processors and memory storing one or more programs for execution by the one or more processors, the one or more programs comprising executable instructions for:
scanning an application program, so as to obtain a list of predefined tasks corresponding to the application program;
comparing the list of predefined tasks with a preset white list of tasks;
removing a matched task from the list of predefined tasks, so as to obtain a new task list, so that a user selects a task according to a need from the new task list for execution;
detecting one or more user selections of members of the new task list;
updating the new task list and the preset white list of tasks according to the user selections; and
performing the updated new task list using the application program.

18. The non-transitory computer readable storage medium of claim 17, wherein the white list of tasks is updated by:
during a predefined time period:
monitoring user activities on a task in the white list of tasks; and
removing the task from the white list of tasks based on a comparison of the monitored user activities with a set of predefined criteria.

19. The non-transitory computer readable storage medium of claim 18, wherein the monitored user activities include one or more of: a period of time the user using a second application associated with the task, a number of times the user starting the second application, a number of times the user terminating the second application, and a number of times the user updating the second application.

20. The non-transitory computer readable storage medium of claim 18, wherein the set of predefined criteria is defined based on multiple users' usage pattern of a second application associated with the task.
